(19) United States
(12) Patent Application Publication
(10) Pub. No.: US 2015/0242772 A1
(43) Pub. Date: Aug. 27, 2015

(54) PORTAL FOR ACCESSING DATA SETS

(71) Applicant: Creative Mobile Technologies, LLC, Long Island City, NY (US)

(72) Inventors: John J. Backof, II, Westchester, PA (US); Mitchell Dinowitz, Dix Hills, NY (US)

(21) Appl. No.: 14/630,784

(22) Filed: Feb. 25, 2015

Related U.S. Application Data
(60) Provisional application No. 61/945,592, filed on Feb. 27, 2014.

(51) Int. Cl. G06Q 10/06

(52) U.S. Cl. CPC G06Q 10/0631

(57) ABSTRACT

A portal includes a processor to determine real-time and historical trip information for a vehicle. The real-time and historical trip information are determined from message sent by at least two protocols. An interface displays the real-time and historical trip information.

### CROSS-REFERENCE TO RELATED APPLICATIONS

This application claims priority to U.S. Provisional Patent Application Ser. No. 61/945,592, filed Feb. 27, 2014, the entire contents of which are incorporated by reference herein.

### BACKGROUND

A portal can include a website or other type of portal that allows users to connect to information over a network, e.g., the Internet. The portal can bring information together from diverse sources in a uniform way. The portal can allow multiple users to access the information at the same time. Variants of portals include mashups and intranet dashboards as a couple examples.

### BRIEF DESCRIPTION OF THE DRAWINGS

In association with the following detailed description, reference is made to the accompanying drawings, where like numerals in different figures can refer to the same element.

FIG. 1 is an exemplary environment for tracking vehicles.

FIG. 2 is a screenshot of an example dashboard of the portal user interface for instant access to key market metrics.

FIG. 3 is a screenshot of the portal showing an example real-time summary to view activity hotspots.

FIG. 4 is a screenshot of an example portal heat map.

FIG. 5 is a screenshot of the portal showing example real-time movement of traffic and vehicles.

FIG. 6 is a screenshot of the portal showing example historical data.

FIG. 7 is a screenshot of the portal showing an example view of ride/job details.

FIG. 8 is a screenshot of the portal showing an example quick view to identify historical trends.

FIG. 9 is a block diagram of an example architecture for an infrastructure of the portal.

FIG. 10 is a block diagram of an example topology and message processing for the portal.

### DETAILED DESCRIPTION

A portal is described that provide an interface to access information. In some implementations, the portal can be cloud-based. The portal can be used in any industry that can benefit from applications which gives real-time and historical access to data. A couple examples include transportation fleet management and/or regulation, including taxis, black cars, limousines, buses, etc. The portal interface described herein can display user-friendly information obtained by processing large amounts of data collected from various access points, e.g., vehicles, throughout a network.

The portal can include a cloud-based interface to enable access by user devices to accurate, comprehensive and complete data sets through customized reporting tools in order to process, search and aggregate large data volumes across the transport industry, including in relation to taxis, limousines, buses and other for-hire vehicles (any class of vehicles). In other implementations the portal can be server-based or web-based, etc. The geo-parameters which form the boundaries of the territory within which such information is collected are customizable, e.g., a tracked area. The portal's collection of such information can enable user to effect a real-time assessment of supply and demand for vehicles in the tracked area; allow users to generate internally and for external use detailed reporting sets, which can be custom-built for users or selected from a range of pre-set reports, greatly reducing analysis, budget, and externally analyst costs; enforce compliance of vehicles with applicable laws and regulations in the tracked area, such as speeding laws, fare calculation, licensed driver regulation, vehicle operating authorization, long-hauling prohibitions, equipment failure and other requirements; direct enforcement agents to specific vehicles or zones where violative activity is occurring in real-time (as opposed to “cruising” for violators, waiting for violations to occur, etc.); incorporate existing systems into the data stream to generate additional alert messages (e.g., license fee payment status, ticket violations, etc.) or to provide industry-wide functionality, e.g., centralized dispatching or e-hail integration to allow passengers to download a single mobile phone app with access to all participating city vehicles; and/or audit the policies, rules, regulations or oversight in the tracked area, and whether any changes to the same are required.

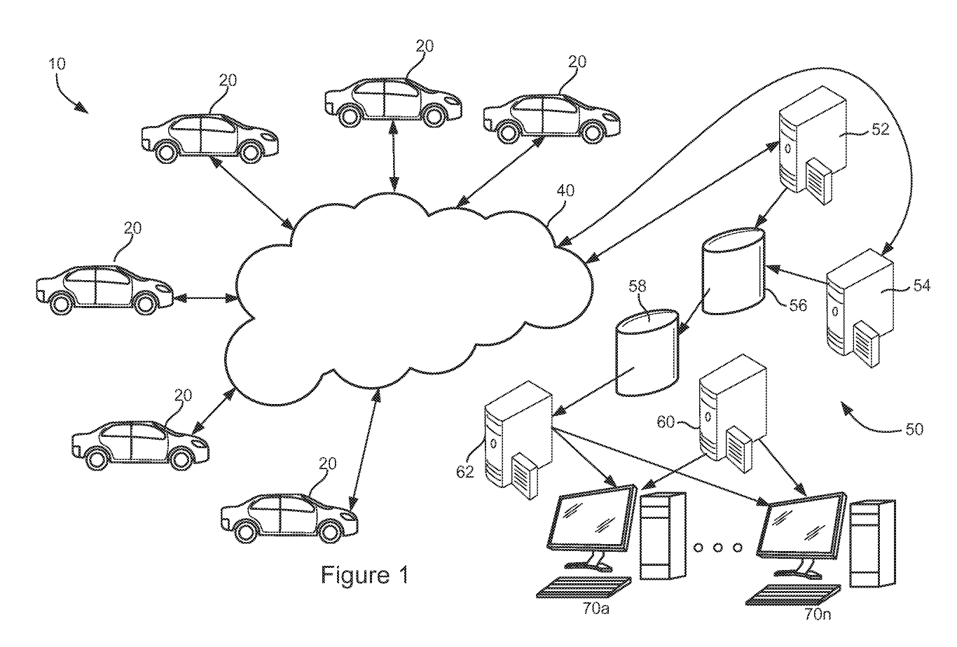

FIG. 1 is an exemplary environment 10 for tracking vehicles 20, e.g., taxicabs. The vehicles 20 can include sensors, e.g., for speed and occupancy, positioning units, passenger interface modules, communication devices, e.g., Wi-Fi, Bluetooth, cellular and various other types of electronic equipment, e.g., for monitoring operation of the vehicles 20 and communicating with the vehicles 20. A communication network 40 can transmit various types of information to and from the vehicles 20. The environment 10 may utilize the communication network 40 to connect a service provider 50, e.g., Creative Mobile Technologies, LLC (CMT).

The service provider 50 can receive and send information from and to the vehicles 20. For example, the service provider 50 can receive data via a user datagram protocol (UDP) at a UDP collector 52. The data can include GPS positional data and other data about the operating state of a vehicle. The service provider 50 can also receive other data, e.g., trip data, ad stats, rate change data, etc., with a different protocol, e.g., transmission control protocol (TCP), at a TCP collector 54. Data from the UDP collector 52 and/or TCP collector 54 can be processed by a data indexer 56 and stored in a data storage 58. A search engine server 60 can access and process data from the data indexer 56 and a separate or combined long term storage server 62 can access and process data from the data storage 58. Interface devices 70a-70n can access and display the processed data, e.g., via personal computers, laptop computers, personal digital assistants, smart phones, tablets, etc.

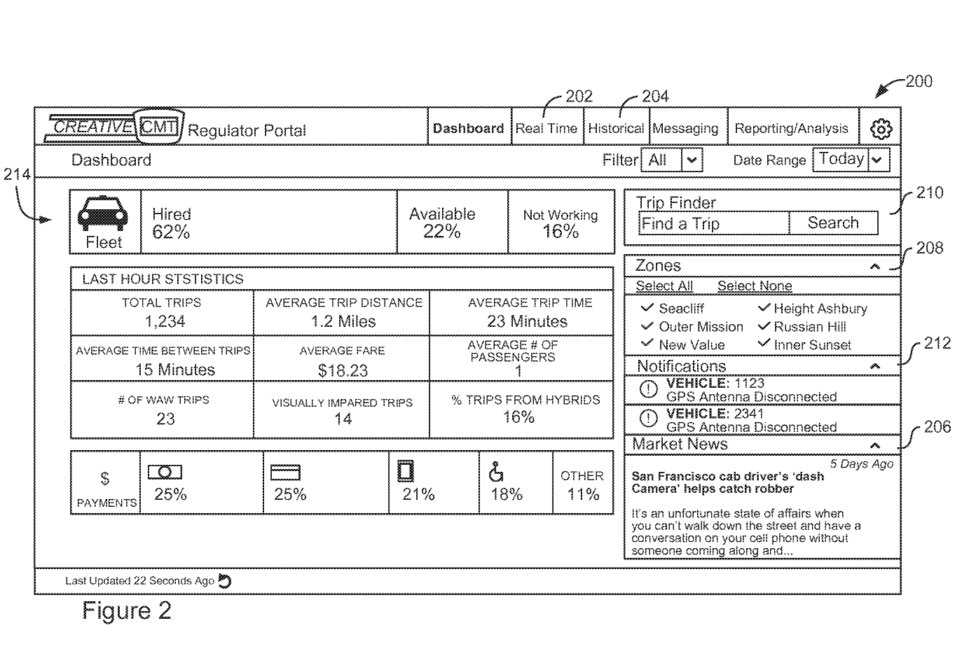

FIG. 2 is a screenshot of an example dashboard 200 of the portal user interface to provide access to market metrics. The dashboard can provide both real time 202 and historical views 204, access to relevant market news 206, sliced by zone or neighborhood 208, with quick access to find vehicles 20 and/or trips 210. The dashboard 200 of the portal can display important notifications and alerts 212 in real time. The dashboard 200 can provide a landing page for users. The dashboard can simultaneously display various information 214, e.g. processed information that is collected from vehicles 20 in the network.

Current Market Utilization %: This percentage can reflect the percentage of available vehicles 20 which are working The range of time over which this percentage is calculated by the portal in a range which can be customized. The market utilization percentage can be determined as an expression of how many vehicles 20 are engaged, e.g., 48% of available taxis are working.

Current Fleet Utilization %: This percentage can reflect the percentage of working vehicles 20 which are hired. The range of time over which this percentage is calculated is a range which can be customized. The fleet utilization percentage can be determined as an expression of how many vehicles 20 are hired, e.g., 74% of working taxis are hired.

Daily Payment Type Bar Chart: The daily payment type bar chart is a chart showing, from the total payments made in any day by the vehicles 20 in the tracked area, which proportions have been made by cash, credit, phone, or other.

Fleet breakdown: The fleet breakdown can describe over a period of time, the specified breakdown rates for different categories of vehicles 20 (e.g., carriage cab 741 vehicles 20, choice cab 200 vehicles 20, independents 567 vehicles 20, etc.).

Average Time Between Trips: This entry can describe the average time it takes for a vehicle to go from a status of in-trip to available within a tracked area. The range of time over which this percentage is calculated can be customized.

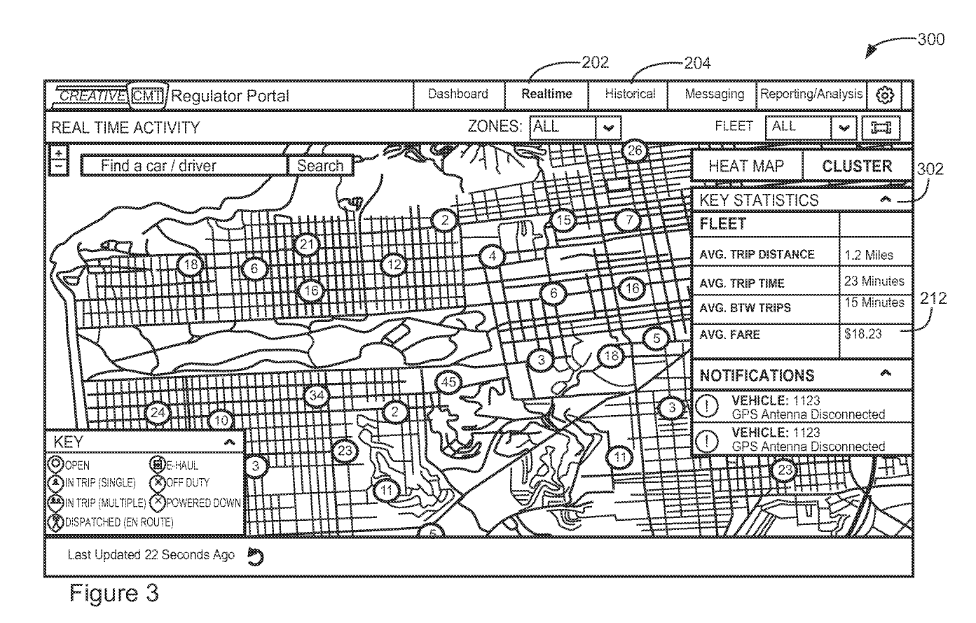

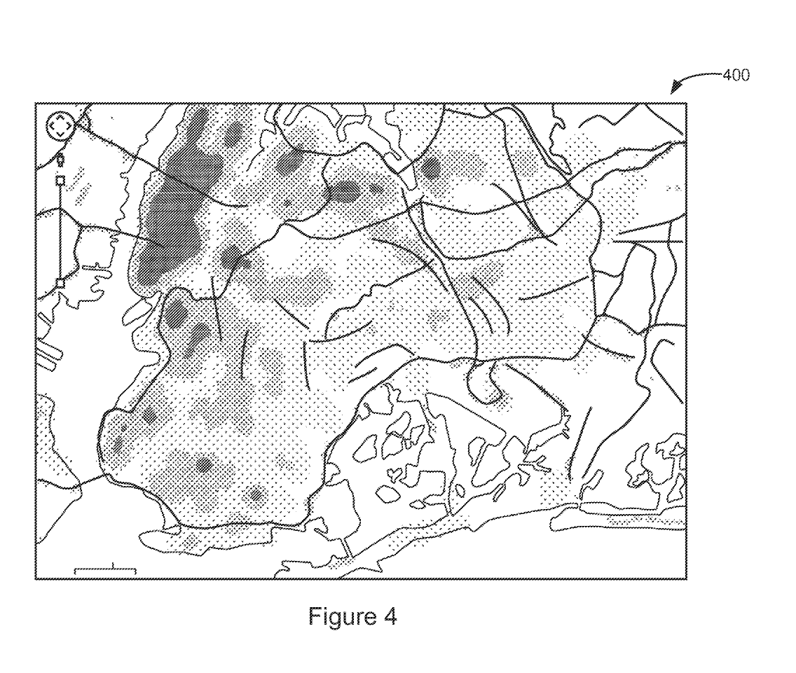

FIG. 3 is a screenshot of the portal showing an example real-time summary 300 to view activity hotspots in the tracked areas. The summary 300 can allow a user to drill in to the map by zone or fleet of vehicles. Metrics 302 can be collected and updated in near real time (e.g., 3-5 sec). Other update times are possible. Metrics can include fleet information, average trip distance, average trip time, average trips, average fare, etc. The vehicles 20 can be viewed as clusters or presented on a heat map, pie charts and/or other graphical representation of data where the individual values can be represented as colors, shapes, etc. For example, in FIG. 4, the heat map 400 can show concentrations of vehicles 20 as colors overlaid on a city map, a section of a city, a country, etc. A designated color, e.g., red, can indicate a number of vehicles 20 greater than z, a determined number, for the area. Yellow can indicate and number of vehicles 20 in the area being between x and z, blue can indicate a number of vehicles 20 present in the area less than x, etc. Specified vehicles 20 or drivers can be indicated on the map.

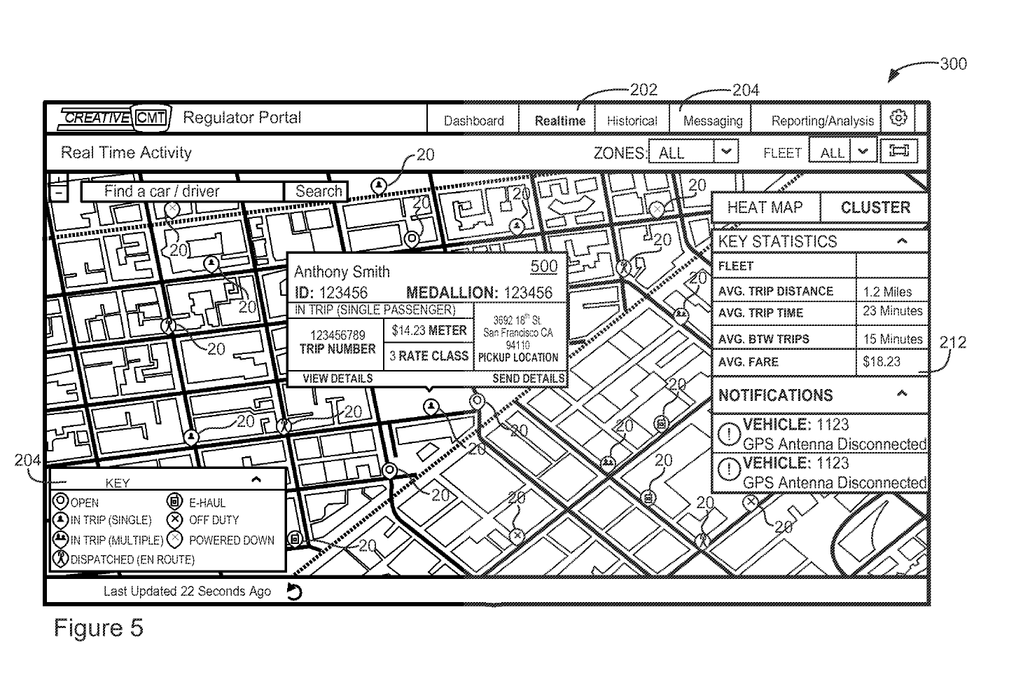

FIG. 5 is a screenshot of the portal showing example real-time movement of traffic and vehicles 20. The view 500 can be filtered by current meter status or dispatch status. Clicking a vehicle offers a detailed view 500 of the specified vehicle and its current state. Individual vehicles 20 can be searched and tracked.

The status 502 of any vehicle 20 can include, for example, whether the vehicle 20 is available (the vehicle is empty but available to pick up passengers), in-trip (the vehicle is occupied with passengers), powered down/out of commission (the vehicle is empty and unavailable to pick up passengers), off-duty (the vehicle is off-duty), e-hailed (the vehicle is occupied with passengers who hailed the vehicle using an e-hail application or online service), and dispatched status.

For example, the map can show vehicle concentration information depending on the size of the market and the number of vehicles 20. The map can be configured to show areas with both higher and lower concentrations of vehicles 20, either in the form of the heat map or as vehicle clusters, etc. The map can also provide pop-up trip information so that the vehicles 20 which are isolated through zoom-in can have pop-up screens of information, which contain driver ID (name and picture), trip number, current meter amount, current rate, and pickup location.

Real time notifications 212 and violations can be provided, and offenders can be dealt with. Rate and Zone Violation: List daily violators, show current violators, and State and historical violations, etc. Speed Violations: real-time and historical, etc. Other Violations: scan violations, bad meter timestamp (e.g., capture the GPS disconnect indicator, and have a filter that allows the portal to display cars where the meter timestamp is outside some X minutes (plus or minus), bad GPS data, and bad network time protocol (NTP) data, bad audio connections or other equipment failures, etc. Alerts can be provided in response to material violations, notifications may be programmed in certain jurisdictions to be sent (e.g., via email, short message service (SMS), web user interface (UI) popup or other) to alert user devices of a breach or breaches.

In one implementation, a regulator or other user determines, through the comprehensive and accurate real-time and historical data available through the portal, that a market, neighborhood or class of citizens (e.g., the disabled) in its jurisdiction is consistently underserved. The regulator or other user can, on the strength of this information, implement a requirement that new measures be adopted to incentivize or mandate that vehicles 20 be made available to such underserved market, neighborhood or class of citizens. Taxi, limousine and for-hire transportation regulators, are dedicated to improving the practice of licensing, enforcement and administration of for-hire transportation through the sharing of information and resources. Regulators can include taxi commissions and committees, police departments and other law enforcement agencies with responsibility for taxis, consumer protection and transportation departments of cities and regions, airport authorities, and city, state and federal agencies responsible for limousines and other motor carriers.

The portal can provide direct communication with the vehicles 20, to allow users, e.g., dispatchers, to communicate directly with vehicles 20 based on information collected, for example, rerecorded messages, such as “You Are Currently in a Prohibited Zone” in the event a vehicle is outside a geographic zone it is authorized to operate in. Automated notifications can be sent to vehicles 20 based on determined rules. Messages may be automatically sent to a vehicle 20 based on behavioral patterns or violation over time, e.g., “You Have Exceeded the Speed Limit 25 Times in the Last 3 Hours.”

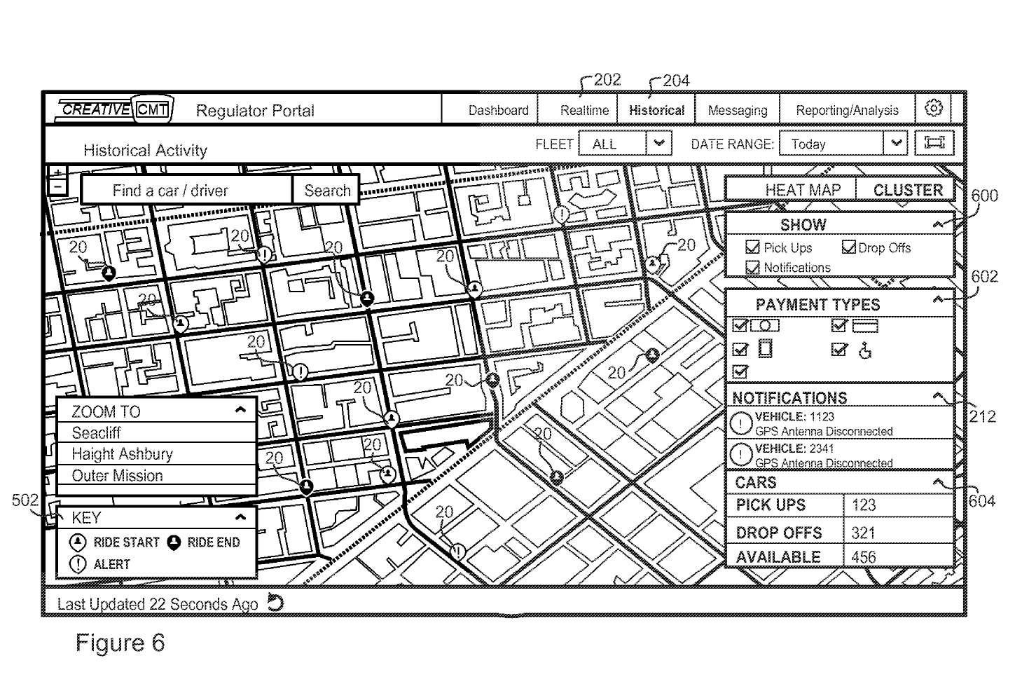

FIG. 6 is a screenshot of the portal showing example historical data. The portal can allow for a quick search historical trip, time stamp and global positioning satellite (GPS) information, e.g., location data, etc. of the vehicles 20. The data can be filtered by zone or fleet, or both. The portal can allow a view of pickup/drop off clustering for cluster analysis. The view of the pickup/drop off can be displayed to represent a catalogue of locations within a tracked area where individuals are picked up and dropped off, including times of day and dates. The pick-up and drop-off information can be displayed as clustered views and represented as a heat map. Ratios of pick-up/drop-off can be determined and displayed. Latitude/longitude input comes from bounds of zoom level or type an address and provided radius. Ratios of available/pick-up can also be determined and displayed. Latitude/longitude input comes from bounds of zoom level or type an address and provided radius.

A drop pin function allows portal interface users to drop a virtual pin on a map to select an area and receive, with respect a fixed radius of the geo-location of that pin, the pin area, the number of vehicles 20 in the pin area, the average speed in the pin area, and the likelihood of hailing a vehicle (taxicab) in the pin area. The pin area can provide a number of vehicles 20, an average speed of the vehicles 20, a likelihood of hailing a cab in area. The pinned area can also provide historical metrics over time, e.g., a taxi score of 0.45 now for the area, and a score of 1.59 at 4:00 pm. A pin drop can provide a visualization of where trips that originated from that area were dropped off. For example, once people arrive at an airport, the destinations they travel to from there, where people who are staying at the Hilton Hotel get dropped off, etc.

The maps of the service areas can be used to help determine underserved areas. Tools on the map, including a slider, can be provided to adjust the date and time of displayed map so that the user can compare the data over time. For example, the information on the map can change depending on a time of day, a day of the week, a month, year-to-year, during holidays, depending on the weather, during a crisis etc. the interface can provide selection boxes to determine what information to display 600, e.g., pickups, drop offs, notifications, what payment types 602, e.g., cash, credit card, phone, special needs and other. Another window 604 can display how information about the vehicles 20, e.g., a number of pickups, drop offs and available vehicles at the time.

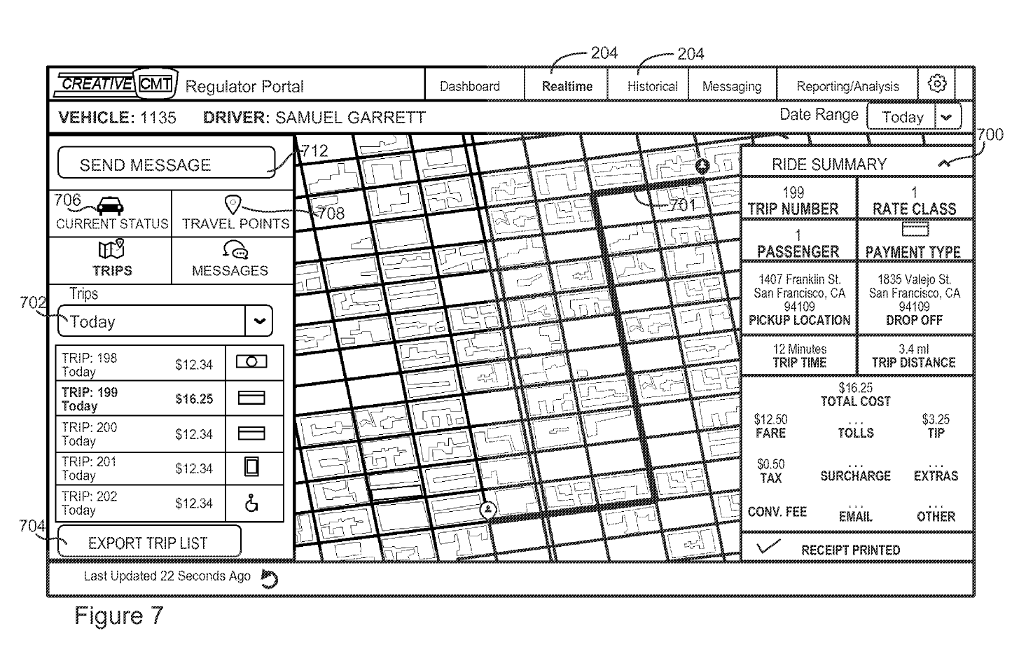

FIG. 7 is a screenshot of the portal showing an example view of ride/job details. The portal can display historical trip recreations 700, including trip route 701 and important events along the way, e.g. trip distance time, pickup and drop off locations, trip number, number of passenger, payment type, weather, trips list, etc. Users can search through past trips 702 of vehicles 20 by any one or more driver information, vehicle, trip number, amount paid, vehicle route locator, etc. with sub-second response times. The data can be exported 704 to an application, e.g., Excel or PDF, for storing and sharing via email, etc. The user interface can also provide access to a current status 706 of the vehicle 20, travel points 708, a list of messages 710, and send a message 712.

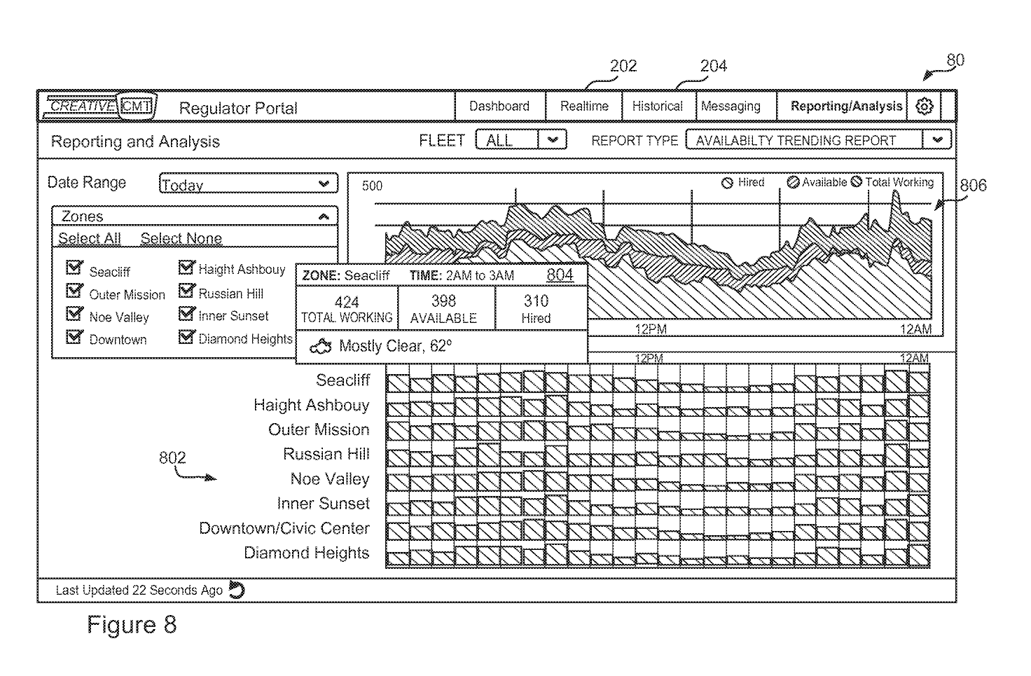

FIG. 8 is a screenshot of the portal showing an example quick view to identify historical trends 800. Trends can help users understand utilization patterns by geography or neighborhood 802, correlate activity and availability to special events and weather conditions 804, and monitor service levels 806. Custom reports can generate form and analytical views.

With the historical trip information, the portal can provide green information. For example, the portal can provide carbon footprint information, e.g., based on an algorithm to establish a footprint in relation to trip time and associated emission projections, and similar calculations, as well as comparisons between carbon footprints associated with trips in vehicles 20 which are hybrid versus those which are regular.

The portal can also provide inventory resource information by collecting and displaying real-time information regarding a number of e-hail vehicles 20, a number of e-hail drivers, vehicles 20 with passenger display screens, meter versions, and audio jack detection with respect to vehicles 20 in any tracked areas.

The portal can also provide infrastructure usage information, e.g., a congestion analysis. The congestion analysis can provide real-time information of sources of congestion, caused by both active and static sources, such as traffic and construction, which can assist in scheduling road/infrastructure maintenance at off-peak times, monitor overall speed, and localize enforcement resources to selected areas or zones. The congestion analysis can also be used for other things, e.g., monitoring traffic flow, to work on ways to improve the flow.

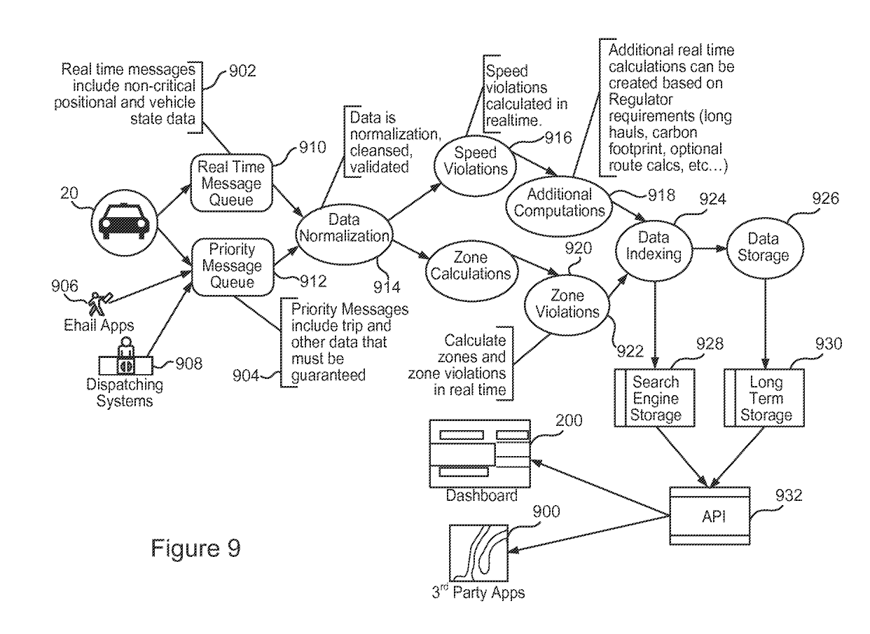

FIG. 9 is a block diagram of an exemplary architecture for an infrastructure of the portal. The architecture can allow for processing data at high rates, from the vehicle to the portal, along with providing real-time processing and analysis of data coming in from the vehicles 20 to facilitate fast query times and avoid expensive queries to data stores. The data can be sent from the vehicles 20 via an application programming interface (API) device located in the vehicles 20. The dashboards 200 and other user interfaces, e.g., third party applications 900, can be displayed on devices of the users, e.g., computer, tablets, smart phones, etc. Types of data collected from the vehicles 20 can include device key, device type, device name, timestamp, latitude, longitude, compass course, velocity, horizontal dilution of position, altitude, GPS operational indicator, ECIO, RSSI, temperature of vehicle equipment and environment, carrier signal quality, signal DBM, signal rating, wheelchair accessibility, vehicle type, modem type, taxi medallion, meter state, logon state, e-hail state, driver ID, fleet name, fleet ID, market segment, shift number, trip number, action codes, current rate class of meter, zone violation indicator, trip total, trip fare, tolls, tax, surcharge, extras, other fees, time since last trip, distance since last trip, trip time, visually impaired trip, passenger count, payment type, job state, emission volumes, oil lite, battery, tire pressure, speed, modem electronic identification (eid), modem phone number, carrier, modem type, etc.

Non-critical data, e.g., GPS positional data, data about the operating state of a vehicle 20, and other data that need not be received and stored for every instance that it is sent, can be sent with a user datagram protocol (UDP) (902). Data that is important to receive in every instance that it is sent, e.g., trip data, ad stats, rate change data, etc., and other guaranteed data, can be sent with a different protocol, e.g., transmission control protocol (TCP) (904). UDP data can be sent from the vehicles 20 and TCP data can be sent from the vehicles 20, e-hail applications 906, dispatching systems 908, etc.

UDP is an alternative to TCP, and together with IP, is sometimes referred to as UDP/IP. Like TCP, UDP can use the Internet Protocol to get a data unit, e.g., datagram, from one computer to another. Unlike TCP, UDP may not provide the service of dividing a message into packets (datagrams) and reassembling it at the other end and UDP does not provide sequencing of the packets that the data arrives in. UDP helps to save processing time because they have very small data units to exchange, and therefore very little message reassembling to do. UDP provides port numbers to help distinguish different user requests and, optionally, a checksum capability to verify that the data arrived intact. The portal architecture can use data sent by two different protocols, e.g., UDP and TCP, to accommodate storage and processing of the large amount of data that is received. For example, critical data can be sent by a protocol that specializes in reliability, but perhaps not speed, and non-critical data can be sent by a protocol that that specifies speed, but perhaps the delivery of messages is less reliable than other protocols. More than two different protocols can also be used.

A processor located in the vehicle 20 can analyze data at the vehicle 20 before sending the UDP or TCP protocol message, which includes the analyzed data. For example, in order to limit the traffic generated by the vehicle UDP pump, the vehicle processor can analyze any combination of global positioning system (GPS) position, meter state, login state and fare data, etc. before generating the status packet to send to the portal architecture. This in vehicle bandwidth reduction strategy may include additional filters and guards as the context of sent data changes.

UDP data can be sent to a real time message queue (910). In one example, a frequency at which data collectors receive UDP traffic is about once every 3 seconds. Other frequencies can be used. These messages are limited to GPS positional data as well as providing key state information used for real-time analysis. TCP collectors receive data when the event occurs in the vehicle 20. For example, New York City taxis produce roughly 50 trips per day. This will yield 100 trip messages per day per car. For example, 2500 cars will produce 50,000 messages per minute or 72 million messages per day. The receivers can handle about more than 3000 messages/sec. Each UDP datagram is roughly 200 bytes. At this size, roughly 10 MB per minute or 14 GB per day of data can be received, not including indexes for searching.

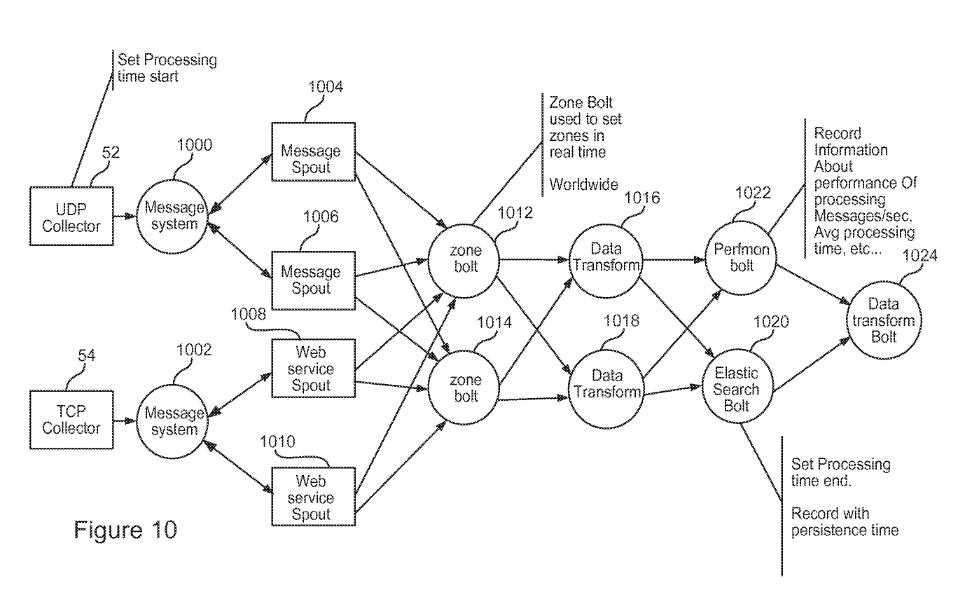

TCP messages from the vehicle 20 can sent from a gateway to a load balancer and on to messaging service (912). An exemplary messaging service is a scalable hosted queue messaging service on the cloud which allows storage of messages as they travel between computers, e.g. AMAZON web services SQS. The received TCP and UDP messages can be normalized, cleansed and validated, e.g., with an application like Cassandra (914). The messages can be processed, e.g., to determine speed violations (916) in real-time, and determine other information like long hauls, carbon footprint, optimal route calculations, etc. (918) The processing can also include zones calculations (920) to determine a zone location of the vehicle 20, and check for violation (922), e.g., in real-time. As exemplary processing is described in FIG. 10. The data can be indexed (924) and stored (926), e.g., using a scalable, high availability database, e.g., Cassandra or other indexing and storage. An example storage is also described in FIG. 1. The data can be separated into fast, easy accessible storage to accommodate searching (928), and into long term storage (930) for non-time sensitive searches. The portal, including dashboard 200 and third party application 900 user interfaces, can connect to the search engine and long term storage via an API 932 to perform data queries of the vehicle data processed by the processors. An exemplary API is the Where API by Creative Mobile Technologies in New York, which provides real time access to vehicle data including positional data, status and summary records.

FIG. 10 is a block diagram of an example topology and message processing for the portal. The diagram shows a real-time computational topology. The message collectors, e.g., UDP collector 52 and TCP collector 54, connect with a high throughput distributed messaging systems 1000, 1002, for example, a Kafka spout, e.g., message spouts 1004, 1006 and web service spouts 1008, 1010, respectively. The real time computational engine processes messages to determine speed/zone violations, equipment failures, carbon footprint, etc. Zone bolts 1012, 1014 are used to set zones in real-time, e.g., using World Wind developed by NASA or other virtual map. Data transform modules 1016, 1018 can process the data from the zone bolts 1012, 1014. An elastic search bolt 1020 can set the processing time end and record with persistence time and persist messages to the elastic search. A perfmon bolt 1022 can record information about performance of processing messages per second, calculate the average processing time, etc. and persists messages to the bolts. Once the computational engine is complete and data messages transformed by a data transform bolt 1024, the messages can be indexed and persisted to both an index storage system, e.g., search engine storage 928 and long term data storage system 930, as needed.

Some advantages of the portal can include enabling user devices access to accurate and complete data, provide customized tools for tracking and monitoring vehicles 20 and passengers, process, search and aggregate capabilities for large data volumes, and through secure technology and industry access. The portal can present fast, easy to read, up-to-date and complete information to assist users in the transport industry in meeting their challenges. The information can be fed from large-scale access to transportation networks across the U.S. (e.g., +25,000 vehicles and hundreds of thousands of drivers), and leverage years of data aggregation and transport industry experience. The portal can leverage new technologies, operating models and market participant impacts upon the taxi industry and regulatory schemes.

The portal can deliver tools, technologies and access to users in connection with the transport industry. User devices in the transport industry can access tools and data which are used to making quick and accurate decisions in a fast evolving market. The portal can display data to enable the industry to properly service the transportation needs of the riding public through centralized dispatch. Information provided by the portal can leverage years of data collected from networks tracking passenger vehicles, and industry experience. The data can include passenger pick up and drop of points, travelled routes, fares, tolls, etc.

The portal architecture can be a horizontal portal to serve several companies in the same economic sector or to the same type of manufacturers or distributors, including scalable cloud-based applications or architectures, spanning multiple redundant data centers. The portal can be capable of processing, storing and searching tens of thousands of data points every second, and tens of millions of data points per day, with sub-second data retrieval times. The portal is capable of searching and aggregating millions of data points in milliseconds. An extensible framework allows data collection from disparate sources (Dispatch Companies, Public Transportation, E-Hail Providers, Police and Fire Departments, etc.) and open application programming interfaces (APIs) are available for numerous integrations with 3^{rd} parties.

The systems, methods, devices, and logic of the portal, vehicle processors and architectures described above may be implemented in many different ways in many different combinations of hardware, software or both hardware and software. For example, all or parts of the system may include circuitry in a controller, a microprocessor, or an application specified integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Many modifications and other embodiments set forth herein will come to mind to one skilled in the art having the benefit of the teachings presented in the foregoing descriptions and the associated drawings. Although specified terms are employed herein, they are used in a generic and descriptive sense only and not for purposes of limitation.

1. A portal, comprising:
a processor to determine real-time and historical trip information for a vehicle, the real-time and historical trip information determined from a message sent by at least two protocols; and
an interface to display the real-time and historical trip information.

2. The portal of claim 1, where the at least two protocols comprise a UDP protocol and a TCP protocol.

3. The portal of claim 1, where the real-time and historical trip information comprises violations by the vehicle.

4. The portal of claim 3, where the violations comprise speeding, out of zone, license fee payment status, long-hauling prohibition, equipment failure or ticket violations.

5. The portal of claim 3, where the processor send a violation alert message to the vehicle.

6. The portal of claim 1, where the real-time and historical trip data comprises vehicle supply and demand information.

7. The portal of claim 1, where the real-time and historical trip data comprises a cluster map or heat map of vehicle locations.

8. The portal of claim 7, where the interface provides the cluster map or heat map for different times of day and different days.

9. The portal of claim 1, where the interface provides cluster analysis information for the vehicles during a day, for holidays and during crisis.

10. The portal of claim 1, where the real-time and historical data comprises market utilization, fleet utilization, payment types, operator breakdown and time between trips.

11. The portal of claim 1, where the interface provides a trip recreation, a carbon footprint analysis or emission projections.

12. The portal of claim 1, where the at least two protocols comprise a protocol that specifies reliability and another protocol that specifies speed.

13. The portal of claim 12, where critical data is sent by the protocol that specifies reliability and non-critical data is sent by the protocol that specifies speed.

14. The portal of claim 1, further comprising a processor located in the vehicle, wherein the processor analyzes at least two of a position data, a meter status data, a login state data and a fare data before sending the message.

15. A method, comprising:
determining a real-time and historical trip information for a vehicle, the real-time and historical trip information determined from message sent by at least two protocols.

16. The method of claim 15, further comprising a cloud-based interface to view the real-time and historical trip information.

17. The method of claim 15, where the real-time and historical trip information comprises searchable driver information.

18. The method of claim 15, where the real-time and historical trip information comprises drop off and pick up information, a number of vehicles in a selected area and a likelihood of hailing taxi in the selected area.

19. A dashboard for a portal, comprising:
a user interface, the user interface to simultaneously display information including a current market utilization percentage for a fleet of vehicles, a current fleet utilization percentage, a daily payment type, an operator breakdown and an average time between trips.

20. The dashboard of claim 19, where the information is obtained from at least two protocols comprising a UDP protocol and a TCP protocol.
